(19) United States
(12) Patent Application Publication
(10) Pub. No.: US 2024/0074007 A1
(43) Pub. Date: Feb. 29, 2024

(54) ELECTROMAGNETIC HEATING DEVICE, NOISE SUPPRESSION METHOD, HEATING CONTROL SYSTEM, AND STORAGE MEDIUM

(71) Applicant: FOSHAN SHUNDE MIDEA ELECTRICAL HEATING APPLIANCES MANUFACTURING CO., LTD., FOSHAN (CN)

(72) Inventors: Jun LEI, FOSHAN (CN); Lutian ZENG, FOSHAN (CN); Chengbin ZHU, FOSHAN (CN); Yunfeng WANG, FOSHAN (CN); Deyong JIANG, FOSHAN (CN); Wenhua LIU, FOSHAN (CN); Liang ZHENG, FOSHAN (CN)

(21) Appl. No.: 18/259,586

(22) PCT Filed: Dec. 24, 2021
(86) PCT No.: PCT/CN2021/141332

§ 371 Date: Jun. 28, 2023

(30) Foreign Application Priority Data
Dec. 29, 2020 (CN) 202011587915.9

(51) Int. Cl. H05B 6/06; H05B 6/44

(52) U.S. Cl. CPC H05B 6/06; H05B 6/44

(57) ABSTRACT

Provided are an electromagnetic heating device, a noise suppression method, a heating control system, and a storage medium, which relate to the field of electromagnetic heating technologies. The noise suppression method includes: in response to determining that any two adjacent heating modules of the electromagnetic heating device operate successively, obtaining a start operating frequency of the last-started heating module of the two adjacent heating modules; and adjusting an operating frequency of the first-started heating module of the two adjacent heating modules based on the start operating frequency of the last-started heating module, to allow the two adjacent heating modules to operate synchronously at a same operating frequency when the last-started heating module starts operating.

### CROSS-REFERENCES TO RELATED APPLICATIONS

The present disclosure is a national phase application of International Application No. PCT/CN2021/141332, filed on Dec. 24, 2021, which claims a priority to Chinese Patent Application No. 202011587915.9, filed on Dec. 29, 2020, the entireties of which are herein incorporated by reference.

### FIELD

The present disclosure relates to the field of electromagnetic heating technologies, and more particularly, to an electromagnetic heating device, a noise suppression method, a heating control system, and a storage medium.

### BACKGROUND

At present, for an electromagnetic heating device having heating regions and corresponding to coils for combined heating, a control method of gradually increasing a power of a heating module to a target power is generally adopted in a process of starting the electromagnetic heating. That is, a rate of change of the driving power in the control method is gradually reduced. However, in a process of starting the heating in two adjacent regions successively, the control method causes synchronization for the directions of magnetic fields of adjacent coils, which in turn causes superposition or cancellation of the magnetic fields of the adjacent coils, to generate electromagnetic noise.

### SUMMARY

The present disclosure provides an electromagnetic heating device, a noise suppression method, a heating control system, and a storage medium. When a last-started heating module starts operating, an operating frequency of a first-started heating module adjacent to the last-started heating module is adjusted to be that the same as an operating frequency of the last started heating module, in such a manner that directions of magnetic fields of coils of the first-started heating module and the last-started heating module are the same, realizing elimination of electromagnetic noise.

In a first aspect, the present disclosure provides an electromagnetic noise suppression method for an electromagnetic heating device. The method includes: in response to determining that any two adjacent heating modules of the electromagnetic heating device operate successively, obtaining a start operating frequency of the last-started heating module of the two adjacent heating modules; and adjusting an operating frequency of the first-started heating module of the two adjacent heating modules based on the start operating frequency of the last-started heating module, to allow the two adjacent heating modules to operate synchronously at a same operating frequency when the last-started heating module starts operating.

According to the electromagnetic noise suppression method for the electromagnetic heating device in the embodiment of the present disclosure, in response to determining that any two adjacent heating modules of the electromagnetic heating device operate successively, the start operating frequency of the last-started heating module of the two adjacent heating modules is obtained. Thus, the operating frequency of the first-started heating module of the two adjacent heating modules is adjusted based on the start operating frequency of the last-started heating module, to allow the two adjacent heating modules to operate synchronously at the same operating frequency when the last-started heating module starts operating. In this way, the operating frequency of the first-started heating module adjacent to the last-started heating module is adjusted to be the same as the operating frequency of the last-started heating module when the last-started heating module starts operating, in such a manner that the directions of the magnetic fields of the coils of the first-started heating module and the last-started heating module are the same, realizing elimination of the electromagnetic noise.

In a second aspect, the present disclosure provides a computer-readable storage medium. The computer-readable storage medium stores an electromagnetic noise suppression program for an electromagnetic heating device. The electromagnetic noise suppression program for the electromagnetic heating device, when executed by a processor, implements the above electromagnetic noise suppression method for the electromagnetic heating device.

According to the computer-readable storage medium in the embodiment of the present disclosure, the electromagnetic noise suppression program for the electromagnetic heating device stored on the computer-readable storage medium, when executed by the processor, can implement that the operating frequency of the first-started heating module adjacent to the last-started heating module is adjusted to be the same as the operating frequency of the last-started heating module when the last-started heating module starts operating, in such a manner that the directions of the magnetic fields of the coils of the first-started heating module and the last-started heating module are the same, realizing elimination of the electromagnetic noise.

In a third aspect, the present disclosure provides an electromagnetic heating device. The electromagnetic heating device includes: a memory; a processor; and an electromagnetic noise suppression program for an electromagnetic heating device stored in the memory and executable on the processor. The processor, when executing the electromagnetic noise suppression program, implements the above electromagnetic noise suppression method for the electromagnetic heating device.

According to the electromagnetic heating device in the embodiment of the present disclosure, by implementing the above electromagnetic noise suppression method for the electromagnetic heating device, the operating frequency of the first-started heating module adjacent to the last-started heating module is adjusted to be the same as the operating frequency of the last-started heating module when the last-started heating module starts operating, in such a manner that the directions of the magnetic fields of the coils of the first-started heating module and the last-started heating module are the same, realizing elimination of the electromagnetic noise.

In a fourth aspect, the present disclosure provides a heating control system for an electromagnetic heating device. The heating control system includes: a first heating module and a second heating module that are arranged corresponding to adjacent heating regions; a first drive module and a second drive module, the first drive module being configured to drive the first heating module to operate, and the second drive module being configured to drive the second heating module to operate; a rectification module configured to rectify power inputted from an alternating current power source to output a power supply, and supply the power supply to the first heating module and the second heating module; a zero-crossing detection module configured to detect a zero-crossing signal of the alternating current power source; and a control module configured to obtain a start operating frequency of the second heating module in response to the first heating module being in operation and the second heating module needing to be started, generate a first control signal and a second control signal based on the zero-crossing signal and the start operating frequency of the second heating module, respectively, adjust an operating frequency of the first heating module through the first drive module based on the first control signal, and drive the second heating module to operate through the second drive module based on the second control signal, to allow the first heating module and the second heating module to operate synchronously at a same operating frequency.

According to the heating control system for the electromagnetic heating device in the embodiment of the present disclosure, the zero-crossing detection module is configured to detect the zero-crossing signal of the alternating current power source. The rectification module is configured to rectify the power inputted from the alternating current power source to output the power supply, and supply the power supply to the first heating module and the second heating module. The first drive module is configured to drive the first heating module to operate. The second drive module is configured to drive the second heating module to operate. The control module is configured to obtain the start operating frequency of the second heating module in response to the first heating module being in operation and the second heating module needing to be started, generate the first control signal and the second control signal based on the zero-crossing signal and the start operating frequency of the second heating module, respectively, adjust the operating frequency of the first heating module through the first drive module based on the first control signal, and drive the second heating module to operate through the second drive module based on the second control signal, to allow the first heating module and the second heating module to operate synchronously at the same operating frequency. In this way, the operating frequency of the first-started heating module adjacent to the last-started heating module is adjusted to be the same as that the operating frequency of the last-started heating module when the last-started heating module starts operating, in such a manner that the directions of the magnetic fields of the coils of the first-started heating module and the last-started heating module are the same, realizing elimination of the electromagnetic noise.

In a fifth aspect, the present disclosure provides another electromagnetic heating device. The other electromagnetic heating device includes the above heating control system for the electromagnetic heating device.

According to the other electromagnetic heating device in the embodiment of the present disclosure, with the above heating control system for the electromagnetic heating device, the operating frequency of the first-started heating module adjacent to the last-started heating module is adjusted to be the same as that the operating frequency of the last-started heating module when the last-started heating module starts operating, in such a manner that the directions of the magnetic fields of the coils of the first-started heating module and the last-started heating module are the same, realizing eliminations of the electromagnetic noise.

Additional embodiments of the present disclosure will be provided at least in part in the following description, or will become apparent at least in part from the following description, or can be learned from practicing of the present disclosure.

### BRIEF DESCRIPTION OF THE DRAWINGS

The above embodiments of the present disclosure will become more apparent and more understandable from the following description of embodiments taken in conjunction with the accompanying drawings.

FIG. 1 is a flowchart of an electromagnetic noise suppression method for an electromagnetic heating device according to an embodiment of the present disclosure.

FIG. 2 is a schematic structural diagram of an electromagnetic heating device according to an embodiment of the present disclosure.

FIG. 3 is a waveform diagram of an electromagnetic noise suppression method for an electromagnetic heating device according to an embodiment of the present disclosure.

FIG. 4 is a waveform diagram of an electromagnetic noise suppression method for an electromagnetic heating device according to another embodiment of the present disclosure.

FIG. 5 is a block diagram showing a structure of a heating control system for an electromagnetic heating device according to an embodiment of the present disclosure.

FIG. 6 is a block diagram showing a structure of an electromagnetic heating device according to an embodiment of the present disclosure.

### DETAILED DESCRIPTION OF THE DISCLOSURE

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

An electromagnetic heating device, a noise suppression method, a heating control system, and a storage medium according to the embodiments of the present disclosure are described below with reference to the accompanying drawings.

FIG. 1 is a flowchart of an electromagnetic noise suppression method for an electromagnetic heating device according to an embodiment of the present disclosure.

As illustrated in FIG. 1, the electromagnetic noise suppression method for the electromagnetic heating device includes the following operations.

At S11, in response to determining that any two adjacent heating modules of the electromagnetic heating device operate successively, a start operating frequency of the last-started heating module of the two adjacent heating modules is obtained.

It should be noted that since the heating module of the electromagnetic heating device generally has a high operating frequency, the operating frequency of the heating module can be controlled by controlling a frequency of a drive signal outputted by a drive module.

As an example, start operating frequencies of all heating modules on the electromagnetic heating device may be obtained in advance, and then frequencies of drive signals corresponding to the start operating frequencies may be obtained. The frequencies of the drive signals may be stored in a memory of the electromagnetic heating device. Further, when two adjacent heating modules are determined to operate successively, a frequency of a drive signal required by the last-started heating module of the two adjacent heating modules may be obtained from the memory.

The frequencies of the drive signals required by all the heating modules as described above may also be stored in a cloud server. When two adjacent heating modules are determined to operate successively, a frequency of a drive signal required by the last-started heating module of the two adjacent heating modules may be obtained from the cloud server.

At S12, an operating frequency of the first-started heating module of the two adjacent heating modules is adjusted based on the start operating frequency of the last-started heating module, to allow the two adjacent heating modules to operate synchronously at a same operating frequency when the last-started heating module starts operating.

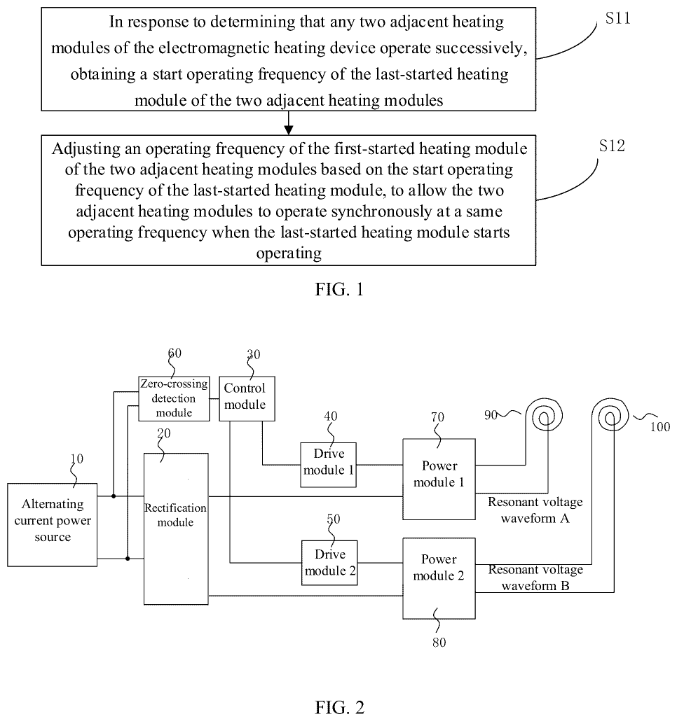

As an example, as illustrated in FIG. 2, an alternating current power source 10 is configured to output an alternating current signal. A zero-crossing detection module 60 is configured to receive the alternating current signal outputted by the alternating current power source 10, process the alternating current signal to obtain a zero-volt detection signal, and transmit the zero-volt detection signal to a control module 30. The control module 30 is configured to control, by means of the drive modules, the power modules to output the harmonic voltage waveform required by the coils, to enable the control module to control the heating modules.

A method for controlling the heating module by the above-mentioned control module 30 may be: in response to controlling the operating frequency of the first-started heating module to be reduced to the start operating frequency of the last-started heating module, controlling the last-started heating module to start operating synchronously at an operating frequency equivalent to that of the first-started heating module.

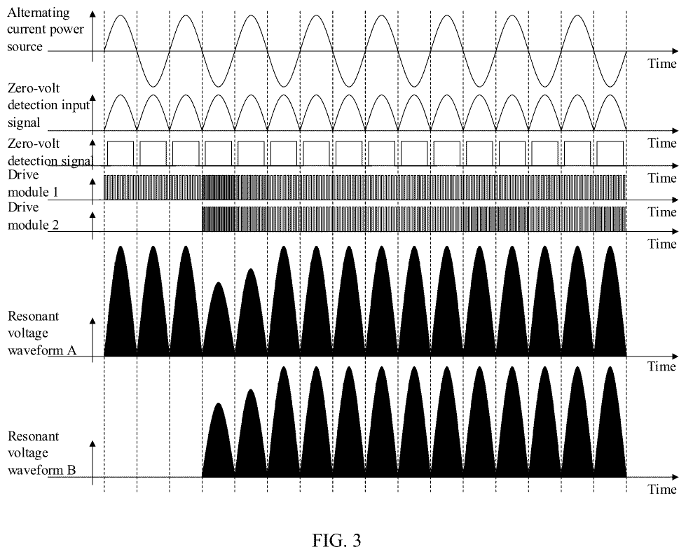

In an embodiment, as illustrated in FIG. 3, before the last-started module starts operating, the control module 30 is configured to control a drive module 40 to output a drive signal having a frequency that is required by the coil 90 to operate normally. A power module 70 is configured to output, based on the drive signal, resonant voltage waveform A that enables the coil 90 to operate normally. The control module 30 is configured to control a drive module 50 not to output any drive signal.

When the last-started module starts operating, the control module 30 is configured to control the drive module 50 to output a drive signal having a frequency that is required by a coil 100 to start heating. A power module 80 is configured to output, based on the received drive signal, resonant voltage waveform B that enables the coil 100 to start heating. The control module 30 is configured to control the drive module 40 to raise the frequency of the outputted drive signal to be the same as the frequency of the drive signal outputted by the drive module 50.

The method for controlling the heating module by the above-mentioned control module 30 may further be: controlling the first-started heating module to stop operating, and controlling, after a predetermined time period based on the start operating frequency of the last-started heating module, the first-started heating module and the last-started heating module to start operating synchronously.

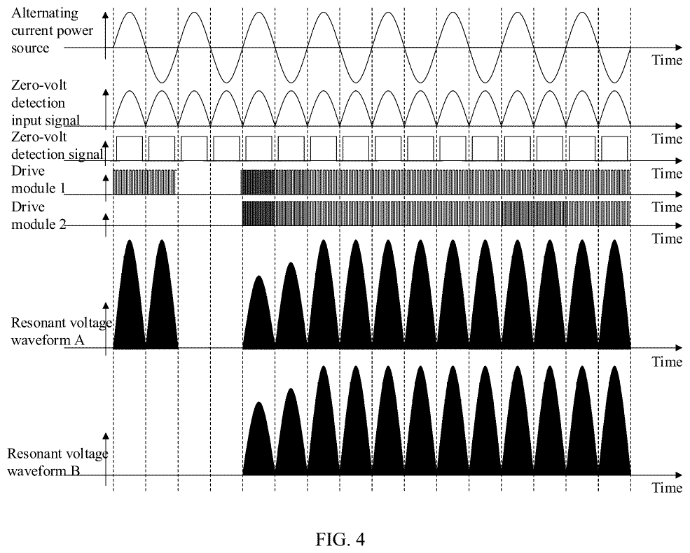

In this embodiment, as illustrated in FIG. 4, the control module 30 is configured to control the drive module 40 to output the drive signal before a first predetermined time period before the last-started module starts operating. The frequency of the drive signal is the frequency required by the coil 90 to operate normally. The power module 70 is configured to output, based on the drive signal, resonant voltage waveform A that enables the coil 90 to operate normally. The control module 30 is configured to control the drive module 50 not to output any drive signal. The above-mentioned first predetermined time period may be set by a user or may be a default predetermined time period of a device.

Within the first predetermined time period before the last-started module starts to operate, the control module 30 is configured to control both the drive module 40 and the drive module 50 not to output any drive signal. That is, within the first predetermined time period before the last-started module starts to operate, the coil 90 started first is controlled to stop heating.

When the last-started module starts operating, the control module 30 is configured to control the drive module 50 to output the drive signal having the frequency that is required by the coil 100 to start heating. The power module 80 is configured to output, based on the received drive signal, resonant voltage waveform B that enables the coil 100 to start heating. The control module 30 is configured to control the drive module 40 to output a drive signal which has the frequency same as that the frequency of the drive signal outputted by the drive module 50.

Therefore, when the last-started coil 100 starts, the frequency of the drive signal outputted by the drive module 40 can be adjusted to be the same as the frequency of the drive signal outputted by the drive module 50.

Operating frequency change trends of the two adjacent heating modules are kept consistent after the two adjacent heating modules operate synchronously at the same operating frequency. That is, as the coil 100 starts a heating process, the frequency of the drive signal required by the coil 100 gradually decreases, the drive module 50 outputs the drive signal that can meet a requirement of the coil 100, and the power module 80 outputs the corresponding resonant voltage waveform B based on the received drive signal, to enable the coil 100 to start the heating process. Meanwhile, the control module 30 controls the drive module 40 to output the drive signal. The frequency of the drive signal outputted by the drive module 40 is the same as that of the drive signal outputted by the drive module 50. The control module 30 and the control module 40 output drive signals that have the same frequency, until the coil 100 completes starting the heating process.

Therefore, a change in frequency of the drive signal outputted by the drive module 40 can be kept synchronous with a change in frequency of the drive signal outputted by the drive module 50 in a process of starting the last-started coil 100.

During a synchronous operation of the two adjacent heating modules, duty ratios of Pulse Width Modulation (PWM) signals of the two adjacent heating modules are independently adjustable from 0% to 50%. That is, although the frequencies of the drive signals outputted by the drive module 40 and the drive module 50 are consistent with each other, the duty ratios of the drive signals outputted by the drive module 40 and the drive module 50 may be different.

It should be noted that the electromagnetic noise suppression method for the electromagnetic heating device according to the embodiments of the present disclosure may also control adjacent heating modules. For example, assuming that three adjacent heating modules A, B, and C are provided, heating module A starts operating first, and heating module C starts operating last, then heating module A may be controlled to keep synchronous with heating module B when heating module B starts heating, and the heating module A and heating module B may be controlled to keep synchronous with heating module C when heating module C starts heating.

In summary, with the electromagnetic noise suppression method for the electromagnetic heating device according to the embodiments of the present disclosure, the operating frequency of the first-started heating module adjacent to the last-started heating module can be adjusted to be the same as that of the last-started heating module when the last-started heating module starts operating, in such a manner that directions of magnetic fields of the coils of the first-started heating module and the last-started heating module are the same, realizing eliminations of electromagnetic noise. Further, in a process of starting the last-started heating module, the direction of the magnetic field of the coil of the first-started heating module adjacent to the last-started heating module is kept synchronous with that of the last-started heating module, generating no electromagnetic noise in the process of starting the last-started heating module.

Further, the present disclosure provides a computer-readable storage medium.

In the embodiments of the present disclosure, the computer-readable storage medium stores an electromagnetic noise suppression program for the electromagnetic heating device. The electromagnetic noise suppression program for the electromagnetic heating device, when executed by a processor, implements the above electromagnetic noise suppression method for the electromagnetic heating device.

With the computer-readable storage medium according to the embodiments of the present disclosure, when the electromagnetic noise suppression program for the electromagnetic heating device stored on the computer-readable storage medium is executed by the processor, the operating frequency of the first-started heating module adjacent to the last-started heating module can be adjusted to be the same as that of the last-started heating module when the last-started heating module starts operating, in such a manner that the directions of the magnetic fields of the coils of the first-started heating module and the last-started heating module are the same, realizing elimination of electromagnetic noise. Further, in the process of starting the last-started heating module, the direction of the magnetic field of the coil of the first-started heating module adjacent to the last-started heating module is kept synchronous with that of the last-started heating module, generating no electromagnetic noise in the process of starting the last-started heating module.

Further, the present disclosure provides an electromagnetic heating device.

In the embodiments of the present disclosure, the electromagnetic heating device includes a memory, a processor, and an electromagnetic noise suppression program for an electromagnetic heating device stored in the memory and executable on the processor. The processor, when executing the electromagnetic noise suppression program, implements the above electromagnetic noise suppression method for the electromagnetic heating device.

The electromagnetic heating device according to the embodiments of the present disclosure implements the above electromagnetic noise suppression method for the electromagnetic heating device. The operating frequency of the first-started heating module adjacent to the last-started heating module can be adjusted to be the same as that of the last-started heating module when the last-started heating module starts operating, in such a manner that the directions of the magnetic fields of the coils of the first-started heating module and the last-started heating module are the same, realizing elimination of electromagnetic noise. Further, in the process of starting the last-started heating module, the direction of the magnetic field of the coil of the first-started heating module adjacent to the last-started heating module is kept synchronous with that of the last-started heating module, generating no electromagnetic noise in the process of starting the last-started heating module.

FIG. 5 is a block diagram showing a structure of a heating control system for an electromagnetic heating device according to another embodiment of the present disclosure.

As illustrated in FIG. 5, a heating control system 100 for the electromagnetic heating device includes a first heating module 101, a second heating module 102, a first drive module 103, a second drive module 104, a rectification module 105, a zero-crossing detection module 106, a control module 107, and an alternating current power source 108.

In the embodiment, the first drive module 103 is configured to drive the first heating module 101 to operate. The second drive module 104 is configured to drive the second heating module 102 to operate. The rectification module 105 is configured to rectify power inputted from an alternating current power source 108 to output a power supply, and supply the power supply to the first heating module 101 and the second heating module 102. The zero-crossing detection module 106 is configured to detect a zero-crossing signal of the alternating current power source 108. The control module 107 is configured to obtain a start operating frequency of the second heating module 102 in response to the first heating module 101 being in operation and the second heating module 102 needing to be started, generate a first control signal and a second control signal based on the zero-crossing signal and the start operating frequency of the second heating module 102, respectively, adjust an operating frequency of the first heating module 101 through the first drive module 103 based on the first control signal, and drive the second heating module 102 to operate through the second drive module 104 based on the second control signal, to allow the first heating module 101 and the second heating module 120 to operate synchronously at a same operating frequency.

With the heating control system, the operating frequency of the first-started heating module adjacent to the last-started heating module can be adjusted to be the same as that of the last-started heating module when the last-started heating module starts operating, in such a manner that the directions of the magnetic fields of the coils of the first-started heating module and the last-started heating module are the same, realizing elimination of electromagnetic noise.

In an embodiment of the present disclosure, the control module 107 is further configured to control, through the second drive module based on the second control signal, the second heating module to start operating synchronously at an operating frequency equivalent to an operating frequency of the first heating module, in response to controlling, through the first drive module based on the first control signal, the operating frequency of the first heating module to be reduced to the start operating frequency of the second heating module.

In an embodiment of the present disclosure, the control module 107 is further configured to control the first heating module to stop operating, and control, after a predetermined time period based on the start operating frequency of the second heating module, the first heating module and the second heating module to start operating synchronously.

During a synchronous operation of the first heating module and the second heating module, duty ratios of PWM signals of the first heating module and the second heating module are independently adjustable from 0% to 50%.

Further, an operating frequency change trend of the first heating module and an operating frequency change trend of the second heating module are kept consistent after the first heating module and the second heating module operate synchronously at a same operating frequency.

It should be noted that reference of other specific implementations of the heating control system for the electromagnetic heating device according to the embodiments of the present disclosure can be made to the above heating control system for the electromagnetic heating device.

In summary, with the heating control system for the electromagnetic heating device according to the embodiments of the present disclosure, the operating frequency of the first-started heating module adjacent to the last-started heating module can be adjusted to be the same as that of the last-started heating module when the last-started heating module starts operating, in such a manner that the directions of the magnetic fields of the coils of the first-started heating module and the last-started heating module are the same, realizing elimination of electromagnetic noise. Further, in the process of starting the last-started heating module, the direction of the magnetic field of the coil of the first-started heating module adjacent to the last-started heating module is kept synchronous with that of the last-started heating module, generating no electromagnetic noise in the process of starting the last-started heating module.

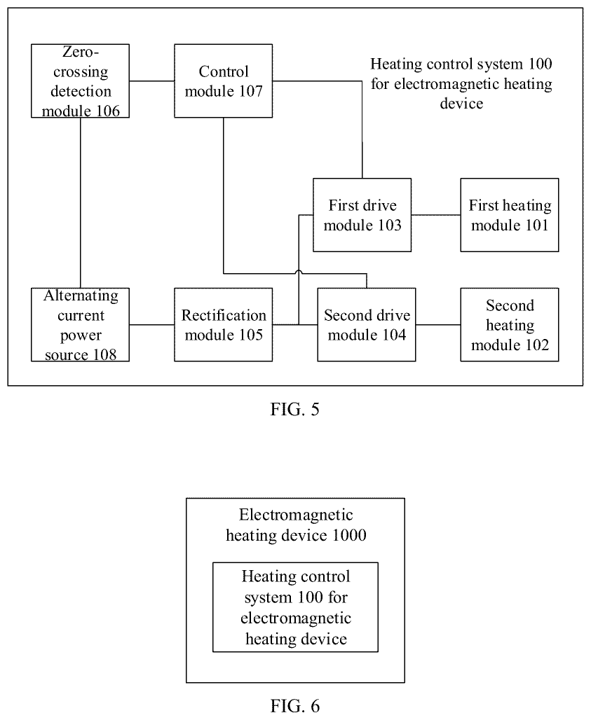

FIG. 6 is a block diagram showing a structure of an electromagnetic heating device according to another embodiment of the present disclosure.

As illustrated in FIG. 6, an electromagnetic heating device 1000 includes the heating control system 100 for the electromagnetic heating device.

With the electromagnetic heating device according to the embodiments of the present disclosure, through the above heating control system for the electromagnetic heating device, the operating frequency of the first-started heating module adjacent to the last-started heating module can be adjusted to be the same as that of the last-started heating module when the last-started heating module starts operating, in such a manner that the directions of the magnetic fields of the coils of the first-started heating module and the last-started heating module are the same, realizing elimination of electromagnetic noise. Further, in the process of starting the last-started heating module, the direction of the magnetic field of the coil of the first-started heating module adjacent to the last-started heating module is kept synchronous with that of the last-started heating module, generating no electromagnetic noise in the process of starting the last-started heating module.

It should be noted that, the logics and/or steps represented in the flowchart or described otherwise herein can be for example considered as a list of ordered executable instructions for implementing logic functions, and can be embodied in any computer-readable medium that is to be used by or used with an instruction execution system, apparatus, or device (such as a computer-based system, a system including a processor, or any other system that can retrieve and execute instructions from an instruction execution system, apparatus, or device). For the present disclosure, a “computer-readable medium” can be any apparatus that can contain, store, communicate, propagate, or transmit a program to be used by or used with an instruction execution system, apparatus, or device. More specific examples of computer-readable mediums include, as a non-exhaustive list: an electrical connector (electronic device) with one or more wirings, a portable computer disk case (magnetic devices), a Random Access Memory (RAM), a Read Only Memory (ROM), an Erasable Programmable Read Only Memory (EPROM or flash memory), a fiber optic device, and a portable Compact Disk Read Only memory (CDROM). In addition, the computer-readable medium may even be paper or other suitable medium on which the program can be printed, as the program can be obtained electronically, e.g., by optically scanning the paper or the other medium, and then editing, interpreting, or otherwise processing the scanning result when necessary, and then stored in a computer memory.

It can be appreciated that each part of the present disclosure can be implemented in hardware, software, firmware or any combination thereof. In the above embodiments, a number of steps or methods can be implemented using software or firmware stored in a memory and executed by a suitable instruction execution system. For example, when implemented in hardware, as in another embodiment, it can be implemented by any one or combination of the following technologies known in the art: a discreet logic circuit having logic gate circuits for implementing logic functions on data signals, an application-specific integrated circuit with suitable combined logic gates, a Programmable Gate Array (PGA), a Field Programmable Gate Array (FPGA), etc.

In the description of this specification, descriptions with reference to the terms “an embodiment”, “some embodiments”, “examples”, “specific examples”, or “some examples” etc. mean that specific features, structure, materials or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner.

In the description of the present disclosure, it should be understood that the orientation or position relationship indicated by the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, etc. is based on the orientation or position relationship shown in the drawings, and is only for the convenience of describing the present disclosure and simplifying the description, rather than indicating or implying that the pointed apparatus or element must have a specific orientation, or be constructed and operated in a specific orientation, and therefore cannot be understood as a limitation of the present disclosure.

In addition, the terms “first” and “second” are only used for descriptive purposes, and cannot be understood as indicating or implying relative importance or implicitly indicating the number of indicated features. Therefore, the features defined with “first” and “second” may explicitly or implicitly include at least one of the features. In the description of the present disclosure, “plurality” means at least two, such as two, three, etc., unless otherwise specifically defined.

In the present disclosure, unless otherwise clearly specified and limited, terms such as “install”, “connect”, “connect to”, “fix” and the like should be understood in a broad sense. For example, it may be a fixed connection or a detachable connection or connection as one piece; mechanical connection or electrical connection; direct connection or indirect connection through an intermediate; internal communication of two components or the interaction relationship between two components, unless otherwise clearly limited. The specific meaning of the above-mentioned terms in the present disclosure can be understood according to specific circumstances.

In the present disclosure, unless expressly stipulated and defined otherwise, the first feature “on” or “under” the second feature may mean that the first feature is in direct contact with the second feature, or the first and second features are in indirect contact through an intermediate. Moreover, the first feature “above” the second feature may mean that the first feature is directly above or obliquely above the second feature, or simply mean that the level of the first feature is higher than that of the second feature. The first feature “below” the second feature may mean that the first feature is directly below or obliquely below the second feature, or simply mean that the level of the first feature is smaller than that of the second feature.

Although the embodiments of the present disclosure have been shown and described above, it can be understood that the above-mentioned embodiments are exemplary and should not be construed as limiting the present disclosure. Changes, modifications, substitutions and modifications to the above-mentioned embodiments within the scope of the present disclosure.

1. An electromagnetic noise suppression method for an electromagnetic heating device, comprising:
in response to determining that any two adjacent heating modules of the electromagnetic heating device operate successively, obtaining a start operating frequency of a last-started heating module of the two adjacent heating modules; and
adjusting an operating frequency of a first-started heating module of the two adjacent heating modules based on the start operating frequency of the last-started heating module, to allow the two adjacent heating modules to operate synchronously at a same operating frequency when the last-started heating module starts operating.

2. The electromagnetic noise suppression method for the electromagnetic heating device according to claim 1, wherein said adjusting the operating frequency of the first-started heating module of the two adjacent heating modules based on the start operating frequency of the last-started heating module comprises:
in response to controlling the operating frequency of the first-started heating module to be reduced to the start operating frequency of the last-started heating module, controlling the last-started heating module to start operating synchronously at an operating frequency equivalent to that of the first-started heating module.

3. The electromagnetic noise suppression method for the electromagnetic heating device according to claim 1, wherein said adjusting the operating frequency of the first-started heating module of the two adjacent heating modules based on the start operating frequency of the last-started heating module comprises:
controlling the first-started heating module to stop operating, and controlling, after a predetermined time period based on the start operating frequency of the last-started heating module, the first-started heating module and the last-started heating module to start operating synchronously.

4. The electromagnetic noise suppression method for the electromagnetic heating device according to claim 1, wherein operating frequency change trends of the two adjacent heating modules are kept consistent after the two adjacent heating modules operate synchronously at the same operating frequency.

5. The electromagnetic noise suppression method for the electromagnetic heating device according to claim 4, wherein during a synchronous operation of the two adjacent heating modules, duty ratios of Pulse Width Modulation (PWM) signals of the two adjacent heating modules are independently adjustable from 0% to 50%.

6. A computer-readable storage medium, having an electromagnetic noise suppression program for an electromagnetic heating device stored thereon, wherein the electromagnetic noise suppression program for the electromagnetic heating device, when executed by a processor, implements the electromagnetic noise suppression method for the electromagnetic heating device according to claim 1.

7. An electromagnetic heating device, comprising:
a memory;
a processor; and
an electromagnetic noise suppression program for an electromagnetic heating device stored in the memory and executable on the processor,
wherein the processor, when executing the electromagnetic noise suppression program, implements a electromagnetic noise suppression method for the electromagnetic heating device, comprising:
in response to determining that any two adjacent heating modules of the electromagnetic heating device operate successively, obtaining a start operating frequency of last-started heating module of the two adjacent heating modules; and
adjusting an operating frequency of a first-started heating module of the two adjacent heating modules based on the start operating frequency of the last-started heating module, to allow the two adjacent heating modules to operate synchronously at a same operating frequency when the last-started heating module starts operating.

8. A heating control system for an electromagnetic heating device, comprising:
a first heating module and a second heating module that are arranged corresponding to adjacent heating regions;
a first drive module and a second drive module, the first drive module being configured to drive the first heating module to operate, and the second drive module being configured to drive the second heating module to operate;
a rectification module configured to rectify power inputted from an alternating current power source to output a power supply, and supply the power supply to the first heating module and the second heating module;
a zero-crossing detection module configured to detect a zero-crossing signal of the alternating current power source; and
a control module configured to obtain a start operating frequency of the second heating module in response to the first heating module being in operation and the second heating module needing to be started, generate a first control signal and a second control signal based on the zero-crossing signal and the start operating frequency of the second heating module, respectively, adjust an operating frequency of the first heating module through the first drive module based on the first control signal, and drive the second heating module to operate through the second drive module based on the second control signal, to allow the first heating module and the second heating module to operate synchronously at a same operating frequency.

9. The heating control system for the electromagnetic heating device according to claim 8, wherein the control module is further configured to control, through the second drive module based on the second control signal, the second heating module to start operating synchronously at an operating frequency equivalent to an operating frequency of the first heating module, in response to controlling, through the first drive module based on the first control signal, the operating frequency of the first heating module to be reduced to the start operating frequency of the second heating module.

10. The heating control system for the electromagnetic heating device according to claim 8, wherein the control module is further configured to control the first heating module to stop operating, and control, after a predetermined time period based on the start operating frequency of a last-started heating module, the first heating module and the second heating module to start operating synchronously.

11. The heating control system for the electromagnetic heating device according to claim 8, wherein an operating frequency change trend of the first heating module and an operating frequency change trend of the second heating module are kept consistent after the first heating module and the second heating module operate synchronously at a same operating frequency.

12. The heating control system for the electromagnetic heating device according to claim 11, wherein during a synchronous operation of the first heating module and the second heating module, duty ratios of PWM signals of the first heating module and the second heating module are independently adjustable from 0% to 50%.

13. An electromagnetic heating device, comprising the heating control system for the electromagnetic heating device according to claim 8.

14. The electromagnetic heating device according to claim 7, wherein said adjusting the operating frequency of the first-started heating module of the two adjacent heating modules based on the start operating frequency of the last-started heating module comprises:
in response to controlling the operating frequency of the first-started heating module to be reduced to the start operating frequency of the last-started heating module, controlling the last-started heating module to start operating synchronously at an operating frequency equivalent to that of the first-started heating module.

15. The electromagnetic heating device according to claim 7, wherein said adjusting the operating frequency of the first-started heating module of the two adjacent heating modules based on the start operating frequency of the last-started heating module comprises:
controlling the first-started heating module to stop operating, and controlling, after a predetermined time period based on the start operating frequency of the last-started heating module, the first-started heating module and the last-started heating module to start operating synchronously.

16. The electromagnetic heating device according to claim 7, wherein operating frequency change trends of the two adjacent heating modules are kept consistent after the two adjacent heating modules operate synchronously at the same operating frequency.

17. The electromagnetic heating device according to claim 16, wherein during a synchronous operation of the two adjacent heating modules, duty ratios of Pulse Width Modulation (PWM) signals of the two adjacent heating modules are independently adjustable from 0% to 50%.
